(19) United States
(12) Patent Application Publication
(10) Pub. No.: US 2026/0257631 A1
(43) Pub. Date: Sep. 3, 2026

(54) VEHICLE ROOF COVER WITH A CABLE CONNECTION

(71) Applicant: Webasto SE, Stockdorf (DE)

(72) Inventors: Rupert KOGLER, Stockdorf (DE); Juraj HUCKO, Stockdorf (DE); Johann SCHUSTER, Stockdorf (DE); Sojka MATEUSZ, Stockdorf (DE)

(21) Appl. No.: 18/846,850

(22) PCT Filed: Mar. 21, 2023
(86) PCT No.: PCT/EP2023/057193

§ 371 Date: Sep. 13, 2024

(30) Foreign Application Priority Data
Mar. 21, 2022 (DE) 10 2022 106 503.0

(51) Int. Cl. B60R 16/02; B60J 7/043; B60R 16/027

(52) U.S. Cl. CPC B60R 16/0215; B60J 7/043; B60R 16/027

(57) ABSTRACT

Embodiments for a cover of a vehicle roof. The cover is provided for movably mounting on a vehicle roof and which has a trailing cable on the cover underside for the electrical connection to a connection line. Provision is made according to the embodiments for the trailing cable to have a cable arrangement with at least two flat ribbon cables which are arranged lying one on another.

### CROSS-REFERENCE TO RELATED APPLICATIONS

This application is a U.S. national phase application filed under 35 U.S.C. § 371 of International Application No. PCT/EP2023/057193, filed on Mar. 21, 2023, pub-lished under WO 2023/180309 A1 on Sep. 28, 2023, designating the United States, which claims priority from German Patent Application Number 10 2022 106 503.0, filed on Mar. 21, 2022, which are hereby incorporated herein by reference in their entirety.

### FIELD

The present embodiments relate to a cover of a vehicle roof, which is provided for movable mounting on a vehicle roof and which on its lower cover side has a trailing cable for electrical connection to a connection line.

### BACKGROUND

Known from DE 196 50 227 C1 is a cover which is movably mounted on a vehicle roof and which by means of a trailing cable is electrically connected to a roof frame. The electrical connection provided by way of the trailing cable is formed by a flexible flat cable. The flexible flat cable is formed so as to be flexurally elastic in such a manner that it is bent in a U-shaped fashion between its fastening locations on the cover and on the roof frame, and said flexible flat cable has such a flexural stiffness that sagging between the fastening locations can be avoided. The flexural stiffness can be increased in that a steel strip is incorporated so as to be centrical in the flexible flat cable. The steel strip is sheathed by a carrier material of the flexible flat cable, such as PVC, for example, and is disposed between power lines which run in each case in the lateral peripheral region of the flexible flat cable. A contact surface of the flexible flat cable that is fixed on the cover can contain a ferromagnetic material which, by virtue of its magnetic characteristics, attracts the steel strip and counteracts sagging of the flexible flat cable.

### SUMMARY

The present embodiments are based on the object of achieving a cover mentioned at the outset, the electrical connection thereof by means of the trailing cable being improved, and to provide a vehicle roof having such a cover.

In the cover mentioned at the outset the object is achieved according to the invention in that the trailing cable has a cable assembly with at least two flexible flat cables which are disposed so as to lie on top of one another.

Advantageous design embodiments of the invention are set forth in the dependent claims.

Because the cable assembly has at least two flexible flat cables which are disposed so as to lie on top of one another, the number of electric conductors of the trailing cable can be increased in comparison to a single flexible flat cable. The thickness or height of the cable assembly of the trailing cable is enlarged in the process, whereas an enlargement of the width of the cable assembly of the trailing cable is not required for a greater number of conductors. The at least two, three, or a plurality of, flexible flat cables form a unit in the cable assembly, said unit being maintained when the trailing cable moves.

By virtue of the not-required enlargement of the width of the cable assembly which is expediently disposed in or close to the lateral peripheral region of the cover, a large see-through area is preserved toward the inside of the cover, next to the trailing cable, in the case of a glass cover. The cover can have a trailing cable on the one lateral region, or have in each case one trailing cable on both mutually opposite lateral regions. Because a cover is designed to be symmetrical, in particular in terms of its two mutually opposite lateral regions on which a cover mounting or cover bearing mechanism is disposed, the opposite lateral region can also be designed to be optically identical, for example using a narrow cladding, trim or foam molding of the cover, if only a narrow trailing cable is disposed on the one lateral region. The see-through area is therefore comparatively large.

Each flexible flat cable has a plurality of electrically conductive strands, conductors or conductor paths which are embedded so as to lie substantially next to one another in one plane, for example in a plastics material such as PVC, or are laminated between two plastic films.

The cable assembly comprises a number of individual flexible flat cables such that the latter can conjointly provide the required total number of conductors. The individual flexible flat cables here can be of an identical type or be identical, or else be formed differently, in particular in terms of the number of conductors. In this way, such a cable assembly is to be configured flexibly as a function of the required total number of conductors. If a trailing cable having, for example, six conductors is required, a cable assembly having two flexible flat cables with in each case three conductors is provided. If only five conductors are required, two such flexible flat cables with in each case three conductors can also be used, whereby only five conductors in total are however utilized.

The cable assembly thus dispenses with the use of such known flexible cables which, for transmitting a comparatively large number of signals, have two, or a plurality of, conductor path layers which are disposed on top of one another in a fixed integral arrangement in only one flexible cable.

The cover is fundamentally a movable roof element of a vehicle roof. The cover is in particular part of a roof system which is capable of opening such as, for example, of a spoiler roof or of a sliding roof, and in its closed position is disposed in a roof opening of the vehicle roof. The cover is, for example, a transparent cover or a glass cover. The cover is mounted so as to be movable on the vehicle roof by means of a bearing installation, and in a longitudinal opening movement is displaceable over an adjacent roof surface part or under such a roof surface part. The trailing cable can also provide a connection between this movable first cover and a further second cover which is disposed so as to be stationary or else movable on the vehicle roof and is movable relative to the first cover.

The flexible flat cables are expediently disposed so as to lie congruently on top of one another if they have the same width or approximately the same widths. However, the flexible flat cables can also be slightly offset from one another in the transverse or width direction. A wider flexible flat cable can be disposed relative to a narrower flexible flat cable in such a manner that it protrudes beyond the narrower flexible flat cable on one lateral periphery or on both lateral peripheries. The flexible flat cables are in particular disposed so as to lie directly on top of one another. Sufficient insulation of the flexible flat cables lying on top of one another is guaranteed by the plastics material sheathing the strands or conductors. However, a barrier layer can also be disposed between the two adjacent flexible flat cables in the case of flexible flat cables lying on top of one another. However, such a barrier layer should not excessively increase the dimensional stability of the cable assembly of a trailing cable, because the flexibility of the trailing cable must remain guaranteed in its trailing movement during opening and closing of the cover.

It can furthermore be provided that the flexible flat cables are fixedly positioned relative to one another, or fixedly connected to one another, at least in a punctiform manner by means of at least one positioning means or one connecting means. Such connecting means or positioning means include, for example, brackets, clips, clamps or else an adhesive bond. However, it also has to be ensured herein that the dimensional stability of the cable assembly of a trailing cable is not excessively increased. The flexible flat cables of the cable assembly are preferably surrounded by a sheath or casing. The sheath offers, for example, protection, insulation and visual design possibilities for the cable assembly, or for the trailing cable, respectively. The sheath is formed, for example, by a tubular woven fabric, by a tubular woven textile fabric, or by a tubular braided fabric. A tubular braided fabric is formed in such a manner, for example, that it can be folded open over its length and automatically close again once the flexible flat cable has been inserted. The flexible flat cables can also be inserted into the sheath. In principle, the sheath is designed in such a manner, or formed from a such a material, that the elasticity and bending property of the trailing cable is not compromised when the cover is being adjusted.

According to a particularly preferred embodiment it is provided that the sheath or casing holds the flexible flat cables so as to be positioned in relation to one another in their arrangement lying one above another or one on top of another. In particular, the sheath braces the flexible flat cables relative to one another. An additional connecting means or positioning means which fixedly connects the individual flexible flat cables to one another, or fixedly positions them relative to one another, is not required. In this way, when such a sheath is used, the cable assembly of the trailing cable is formed and additional connecting means or positioning means are dispensed with.

The cable assembly additionally preferably contains an in particular magnetic spring steel strip. Such a preferably corrosion-free spring steel strip has a thickness of, for example, approximately 0.2 mm. The spring steel strip increases the flexural stiffness of the cable assembly, and counteracts sagging of the free portion of the trailing cable, but nevertheless permits the trailing cable to bend by an angle of, for example, approximately 180° at the U-shaped loop. The spring steel strip expediently has approximately the width of the flexible flat cables. The spring steel strip is preferably received in the sheath so as to bear in the manner of a layer on one of the flexible flat cables. In this way, the spring steel strip is held on the cable assembly by the sheath. Fastening or connecting the spring steel strip to the flexible flat cables is not required. The arrangement of the spring steel strip relative to the flexible flat cables, i.e. on the flexible flat cables or under the flexible flat cables in terms of the installed position of the trailing cable, is selectable.

The contacts of the conductors of each flexible flat cable are expediently connected to assigned contacts of the, for example, connection line on the roof and/or, for example, a connection line on the cover, by means of contact connections. The contact connections are preferably formed as ultrasonically welded connections, or else can be formed as, for example, soldered connections. For example, a round conductor cable represents such a connection line. However, other cables or conductor elements may also form such connection lines. In principle, plug connections or plugs can also provide such contact connections.

According to one preferred embodiment it is provided that a barrier or insulation layer is disposed between the contact connections of two flexible flat cables lying on top of one another. Such a barrier or insulation layer is, for example, an insulating barrier film. The barrier or insulation layer offers a reliable mutual electrical isolation of the contacts of the individual flexible flat cables in the region of the cable connections.

A molded encapsulation which encloses the cable assembly and the connection line in the region of the contact connections is expediently provided. Such a molded encapsulation with a plastics material forms protection for and sealing of the region of the contact connections and expediently also in each case of an adjoining region of the trailing cable and of the connection line.

According to a further preferred embodiment it is provided that the cover has at least one magnet that attracts the magnetic spring steel strip in such a position on the lower cover side that said magnet pulls the trailing cable comprising the spring steel strip toward the lower cover side. It can thus be prevented that the free upper proportion of the trailing cable can sag and potentially also flutter in the event of the cover being adjusted to an open position.

The cover is expediently provided with a peripheral cover frame. The cover frame is preferably formed by means of a peripheral PU foam molding. The at least one magnet is fastened to the cover frame. The molded encapsulation of the contact connections of the trailing cable is expediently fastened to the cover frame. In this way, the molded encapsulation can form a mounting of the trailing cable on the cover. The molded encapsulation of the contact connections on the opposite end of the trailing cable is expediently fastened to a support part which is formed as a support part on the roof, for example of a roof frame or of a guide rail of a cover bearing mechanism, or, as a support part on the cover, is part of a further cover of the vehicle roof.

The molded encapsulation expediently contains a fastening element which is in particular produced by a bi-component injection-molding method. The fastening element is provided for fastening the molded encapsulation to an assigned part of the cover, to an assigned part disposed on the roof, or to an assigned part of a further cover. The fastening element is expediently a part which is produced conjointly with the molded encapsulation, or an independent part which is connected to the molded encapsulation, for example by a form-fitting fastening and/or an adhesive bond.

The fastening element can be made of a soft material, for example of TPU with a hardness 85. The fastening element is preferably made of a hard plastics material, for example of a plastics material such as, for example, polyamide (PA) or polypropylene (PP) or polyurethane (PU), which may also contain reinforcement materials such as glass fibers or the like.

According to one preferred embodiment it is provided that the fastening element has a latching head which is inserted into a fastening cutout on the cover, or on a support part on the roof, in particular on a guide rail preferably of a cover bearing mechanism. The fastening element has, for example, an elongate base web having the likewise elongate latching head for engaging in a correspondingly elongate fastening cutout. Such an elongate fastening cutout is aligned in the longitudinal direction of the trailing cable. However, the fastening element can also be a part which is, for example, round, oval or square in cross section and has, for example, a conical latching head. Such a fastening element can be inserted into an elongate fastening cutout as well as into a fastening cutout which is formed so as to be round or square, for example. The fastening element can be formed with a slot or a longitudinal slot which penetrates at least the latching head and can also extend into the base web, or generally into a base of the fastening element. As a result of the slot or longitudinal slot, the fastening element obtains flexibility which is advantageous for inserting the latching head into the fastening cutout.

According to a further preferred embodiment it is provided that the molded encapsulation has a fastening flange which encloses the flexible flat cables, or the cable assembly, respectively. The fastening flange expediently contains a thickening on its end region that faces away from the molded encapsulation. The thickening is preferably aligned transversely to the longitudinal extent of the flexible flat cables and is formed, for example, by two mutually opposite beads. It is particularly preferable that an end portion of the sheath of flexible flat cables is disposed on the fastening flange, and/or that a shrinkable tubing which encompasses the flexible flat cables, or the cable assembly, or the sheath, respectively, is shrunk onto the fastening flange. The fastening flange enables reliable fastening of the sheath to the molded encapsulation. The thickening, or the beads, respectively, facilitates/facilitates a protection in relation to any unintentional extraction of the sheath that lies tightly on the thickening, or on the beads, respectively. A shrinkable tubing which encompasses the cable assembly or the sheath and is shrunk onto the fastening flange pushes the sheath against the fastening flange and in particular against the thickening, or against the beads, respectively. This guarantees that the flexible flat cables, or the cable assembly, are/is securely held and permanently sealed.

The object is furthermore achieved by a vehicle roof as claimed in claim 15, which has a cover as claimed in one of claims 1 to 14, wherein the cover can furthermore be formed according to the embodiments above. The cover is movably mounted on the vehicle roof. The cover is in particular a glass cover of a sliding roof unit, or a roof element such as, for example, of a panoramic roof.

### BRIEF DESCRIPTIONS OF THE DRAWINGS

The invention will be explained in more detail hereunder by means of exemplary embodiments of covers according to the invention with reference to the drawing.

In the drawing:

FIG. 1 shows a vehicle roof having an adjustable cover which is disposed in a closed position in a roof opening, in a perspective view;

FIG. 2 shows a peripheral region on a lower cover side of the cover which is disposed in the closed position and which is attached to the roof by way of a trailing cable, in a perspective view from above;

FIG. 3 shows the cover which is disposed in the closed position and which is attached to the roof by way of the trailing cable, in a side view;

FIG. 4 shows the cover which is adjusted in the opening direction, having the trailing cable that is entrained in the process, in a side view;

FIG. 5 shows the cover having the trailing cable in a sectional view according to section plane A-A in FIG. 3;

FIG. 6 shows the cover having the trailing cable in a sectional view according to section plane B-B in FIG. 4;

FIG. 7 shows a cable assembly of the trailing cable having two flexible flat cables and associated connection lines, in an isometric view in an exploded illustration;

FIG. 8 shows a sheath of the cable assembly having a spring steel strip received therein, in an isometric view;

FIG. 9 shows the trailing cable comprising the cable assembly and having a contact connection on the end side, which is encapsulated with plastics material and to which the contacts of the connection line are welded, in an isometric view;

FIG. 10 shows a further embodiment of the trailing cable, in an isometric view;

FIG. 11 shows a molded encapsulation of the trailing cable of FIG. 10, in an isometric view and in an enlarged illustration;

FIG. 12 shows the molded encapsulation of FIG. 11, in a longitudinal sectional view;

FIG. 13 shows a peripheral region of the cover having the trailing cable, in an isometric view from below;

FIG. 14 shows the molded encapsulation of the trailing cable assigned to the cover, when disposed on a cover frame, in a cross-sectional view according to section line C-C in FIG. 13;

FIG. 15 shows the molded encapsulation of the trailing cable assigned to a support part on the roof, when disposed on a guide rail on the roof, in a cross-sectional view according to section line D-D in FIG. 13; and

FIG. 16 shows the trailing cable which is held on the cover frame by magnetic attraction, in a cross-sectional view according to section line E-E in FIG. 13.

### DETAILED DESCRIPTION

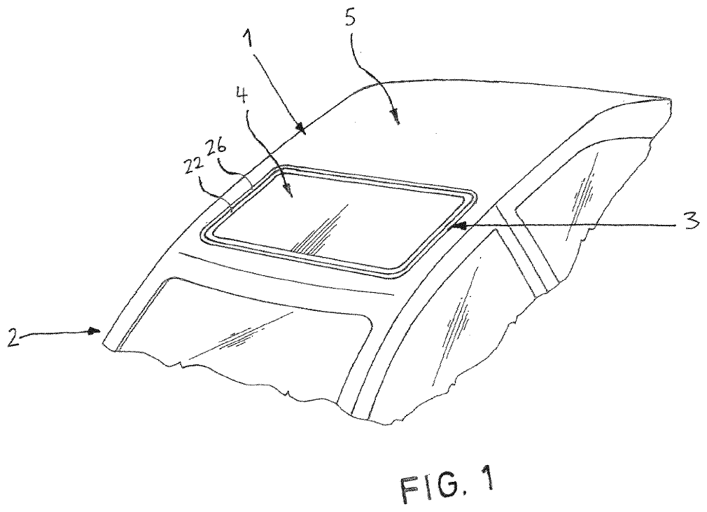

A vehicle roof 1 of a vehicle 2, such as, for example, of a passenger motor vehicle, has a roof opening 3 (FIG. 1) which can be selectively closed or at least partially exposed by a cover 4. The cover 4 is mounted on the vehicle roof 1, for example on a roof frame or a guide rail 37 (FIG. 4) of the vehicle roof 1, so as to be movable in such a manner that, from its closed position, it is displaceable in the vehicle longitudinal direction toward the rear over a rear roof surface 5 or under the rear roof surface 5. The cover 4 is in particular part of a roof system which is capable of opening such as, for example, of a spoiler roof or of a sliding roof. The cover 4 is in particular a glass cover.

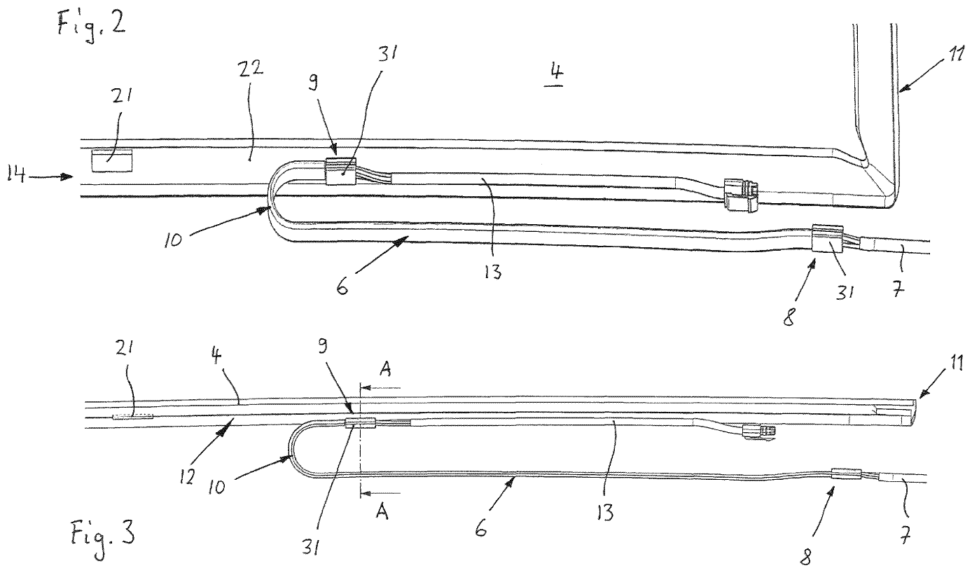

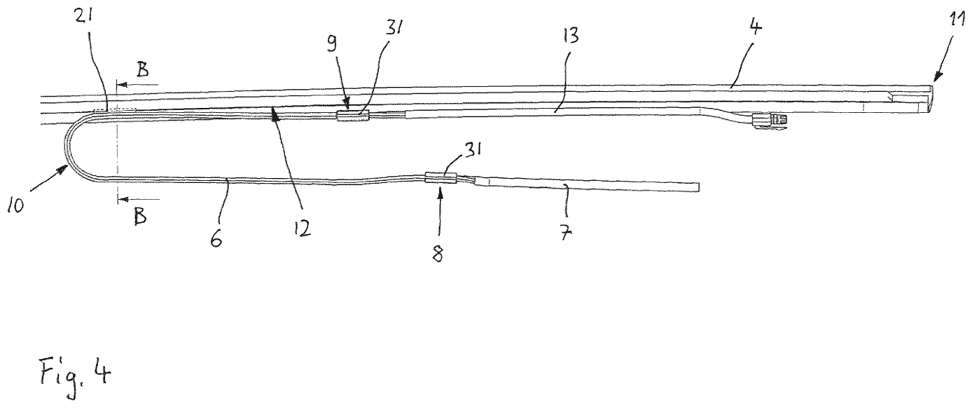

The cover 4 has at least one electrical installation (not illustrated) which is connected to an on-board network on the vehicle by means of a trailing cable 6 (FIGS. 2 and 3) and a connection line 7 on the roof, which is connected thereto. Such an electrical installation comprises electrical or electronic components such as, for example, photovoltaic cells, lighting or sensors and the like. The power supply and the flow of information between the electrical installation, or the components, and the on-board network take place by way of the trailing cable 6.

The trailing cable 6 bears on part of the vehicle roof 1 such as, for example, the roof frame, part of a guide rail 37 of a bearing mechanism of the cover 4, or fundamentally on a support part on the roof, and is connected to the connection line 7 on the roof on its roof-proximal or rear end 8. The trailing cable 6 is bent in the direction of its cover-proximal or front end 9 in a U-shape by an angle of approximately 180° toward the cover 4, so as to form a noose or loop 10 which opens toward the rear cover periphery 11, and on its front end 9 is fastened to the lower cover side 12. The trailing cable 6 is connected to a connection line 13 on the roof at its front end 9. The trailing cable 6 extends in the longitudinal direction of the cover below a lateral peripheral region 14 of the cover 4.

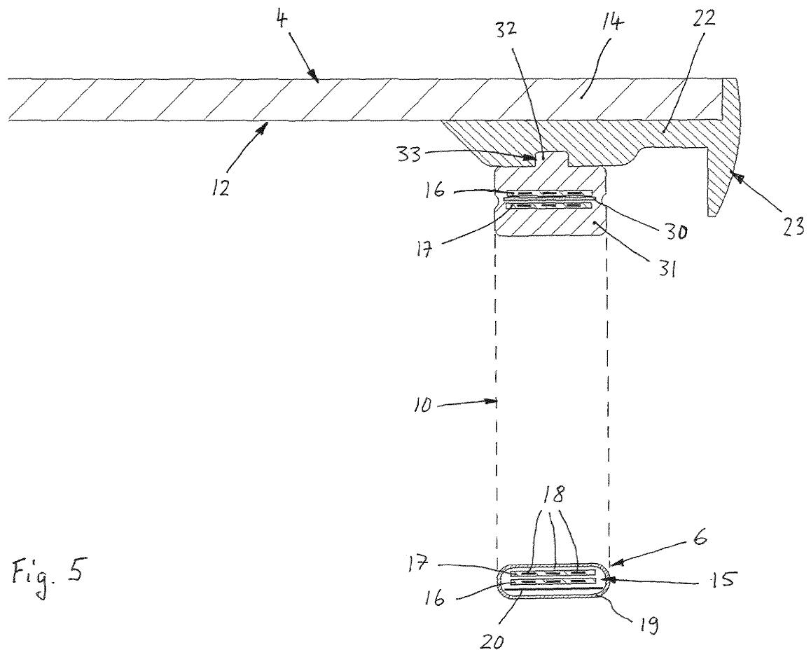

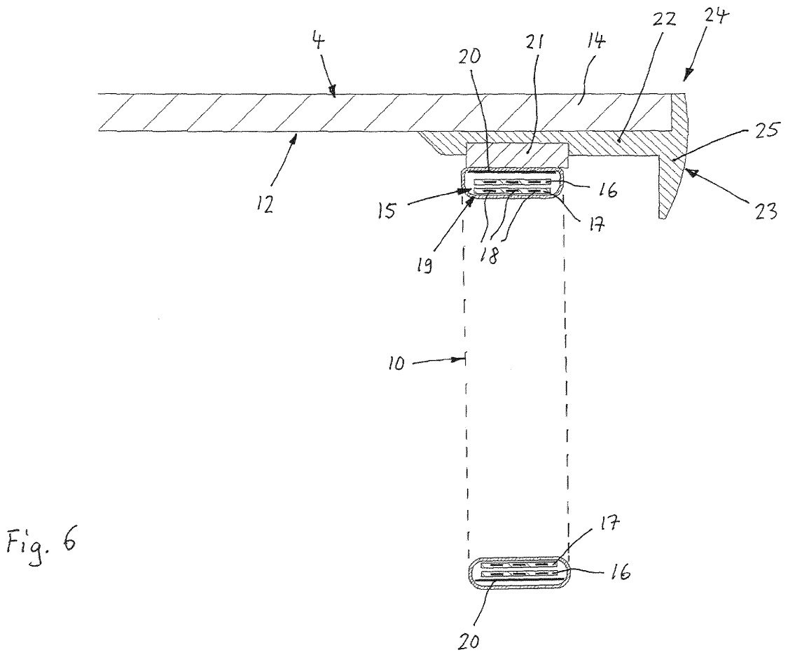

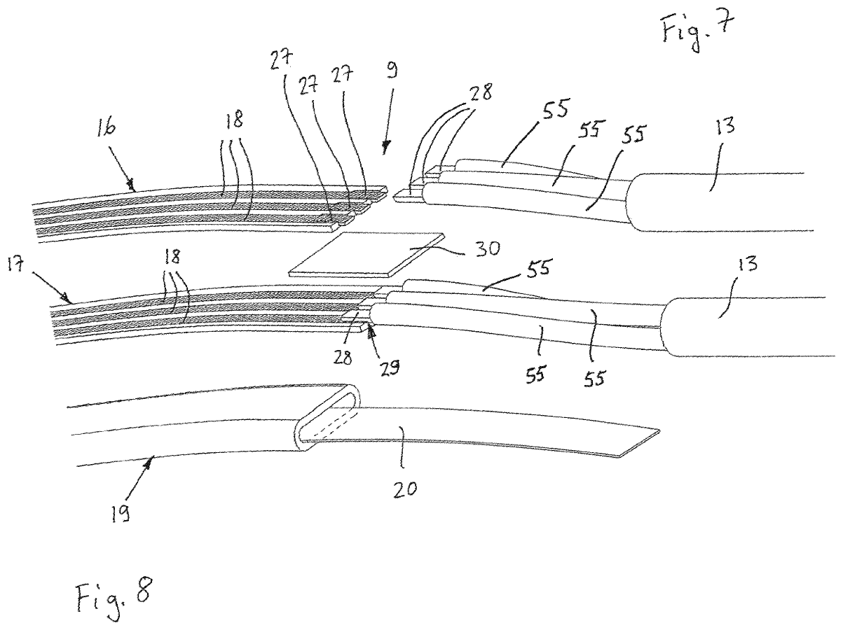

In the case of a closed cover 4 (FIGS. 3 and 5), the loop 10 is located close to the front end 9 of the trailing cable 6 that is fixed to the cover 4. When the cover 4 is adjusted from its closed position (FIGS. 3 and 5) in the longitudinal direction of the cover to an open position according to FIGS. 4 and 6, the trailing cable 6 rolls on the lower cover side 12 so as to maintain the bend in the form of the loop 10, while said trailing cable 6 is raised from the roof frame (not illustrated).

The trailing cable 6 has a cable assembly 15 which contains at least two flexible flat cables 16 and 17 (FIGS. 5 and 6) which are disposed so as to lie on top of one another. In the embodiment illustrated, the cable assembly 15 contains two flexible flat cables 16 and 17 which are preferably of an identical type, contain in each case three conductors 18 and are disposed so as to lie congruently above and on top of one another. The two flexible flat cables 16, 17 are surrounded by a sheath 19. The sheath 19 or casing is, for example, a tubular woven fabric or a tubular braided fabric. The sheath 19 can also be a shrinkable tubing.

A spring steel strip 20 is received in the sheath 19. The spring steel strip 20 preferably bears on that flexible flat cable 16 which is disposed adjacent to the lower cover side 12 when the trailing cable 6 rolls on the lower cover side 12 and bears on the latter.

At least one magnet 21 is fastened to the cover 4 on the lower cover side 12 of the latter. The magnet 21 is provided to attract the magnetic spring steel strip 20 when the trailing cable 6 approaches the magnet 21 from below during rolling. Accordingly, the magnet 21 is attached to the rolling path of the trailing cable 6 on the cover 4 so as to be spaced apart from the front end 9 of the trailing cable 6. The magnet 21 is preferably fastened to a lateral cover frame 22. The cover frame 22 is formed, for example, by a polyurethane foam molding 23 on the lateral cover periphery 24, and extends in the shape of a strip along the lateral cover periphery 24 on the lower cover side 12 in the peripheral region 14 of the cover 14. The cover frame 22 expediently contains a bezel 25 on the lateral cover periphery 24, a cover seal 26 (FIG. 1) bearing on or being attached to said bezel 25.

The magnet 21 is adhesively bonded to the cover frame 22, for example, or is a foam molding on the latter. The magnet 21 can fundamentally also be adhesively bonded to the lower cover side 12 outside a cover frame 22. The magnet 21 can be formed as a punctiform part, or else as an elongate part, so that it extends over a comparatively long region along the rolling path of the trailing cable 6.

When the trailing cable 6 rolls on the lower cover side 12 when opening the cover 4, it is held on the lower cover side 12 by the magnet 21 in such a way that it cannot sag downward toward the vehicle interior.

The magnetic spring steel strip 20 is attracted by the magnet 21 in such a way that it pushes the sheath 19 against the magnet 21. In this way, the spring steel strip 20 holds the cable assembly 15 on the lower cover side 12 by way of the sheath 19. Moreover, the spring steel strip 20 holds the cable assembly 15 and thus the trailing cable 6 on the lower cover side 12, in particular in the region of the bend or loop 10, by virtue of its own resistance to deformation.

The conductors 18 of the flexible flat cables 16, 17 form end-proximal contacts 27 (FIG. 7) at the front end 9 of the trailing cable 6, which are connected to assigned contacts 28 of the connection line 13 on the roof by means of contact connections 29. The contact connections 29 are preferably produced by means of ultrasonically welded connections, or else by means of soldered connections, for example.

A barrier or insulation layer 30 is disposed between the contact connections 29 of two flexible flat cables 16 and 17 lying on top of one another. Such a barrier or insulation layer 30 is, for example, an insulating barrier film. The barrier or insulation layer 30 offers a reliable mutual electrical isolation of the contacts 27 of the individual flexible flat cables 16 and 17 and the contact 28 of the connection line 13 in the region of the cable connections 29. The barrier or insulation layer 30 is expediently introduced after the contact connections 29 have been produced, or after the contacts 27 and 28 have been welded, respectively.

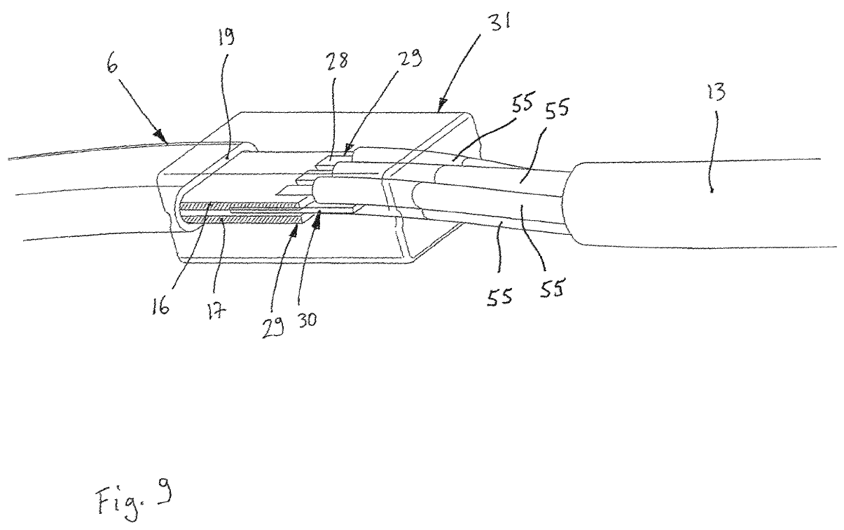

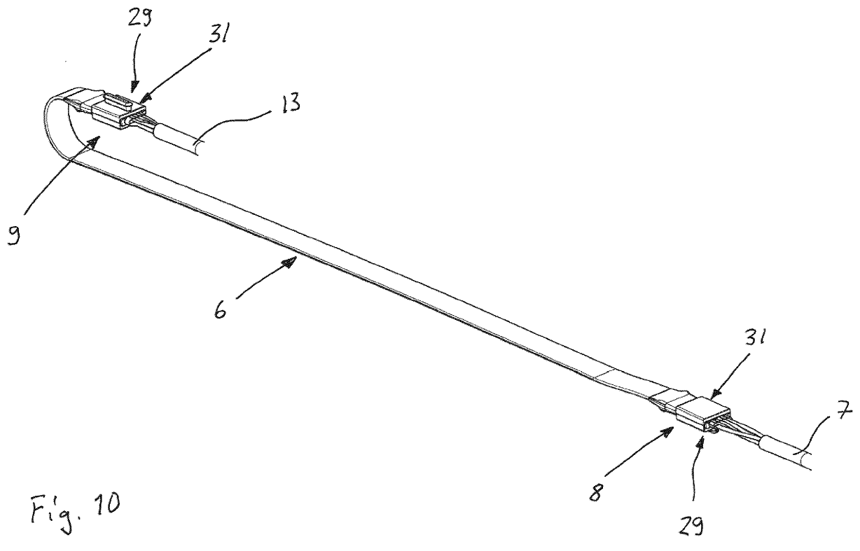

A molded encapsulation 31 which encloses the cable assembly 15 and the connection line 13 in the region of the contact connections 29 is provided (FIG. 9). Such a molded encapsulation 31 is in particular produced from a plastics material or a rubber-like material and offers protection and sealing of this region of the contact connections 29, and expediently also in each case of an adjoining region of the trailing cable 6 and the connection line 14. The molded encapsulation 31 is formed as a cuboid part, for example. The molded encapsulation 31 is fastened to the cover frame 22 by adhesive bonding, for example. The molded encapsulation 31 can also have a protrusion 32 on the upper side, which is inserted into a depression 33 of the cover frame 22. This protrusion 32 can serve to position the molded encapsulation 31 on the cover frame 22, and can also be formed as part of a plug connection, clamping connection or latching connection by way of which the molded encapsulation 31 is fastened to the cover frame 22.

The contact connection 29 described above is expediently formed in the same manner and with the same molded encapsulation 31 on the rear end 8 of the trailing cable 6 for connection to the connection line 7 on the roof.

In the cover 4 according to the invention, the design of the trailing cable 6 with the compact cable assembly 15 having a plurality of flexible flat cables 16, 17 thus enables an increase in the number of conductors 18 while maintaining a small width of the trailing cable 6. Accordingly, the width of a see-through area of a cover 4, for example of a sliding roof or of a roof element, is not reduced even when the number of required conductors 18 is increased. The reinforcement of the trailing cable 6 by means of the spring steel strip 20, and/or the magnetic force of the magnet 21 attracting the trailing cable 6, prevent/prevents sagging and fluttering of the trailing cable 6 on its free cable length.

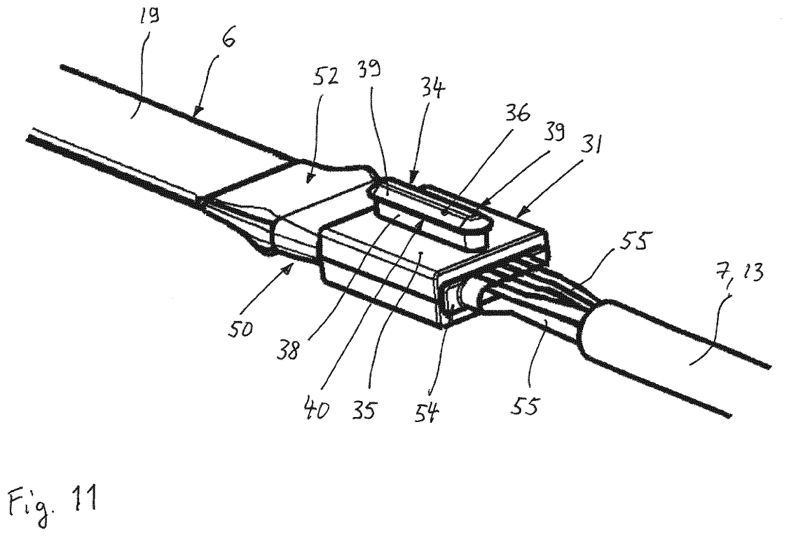

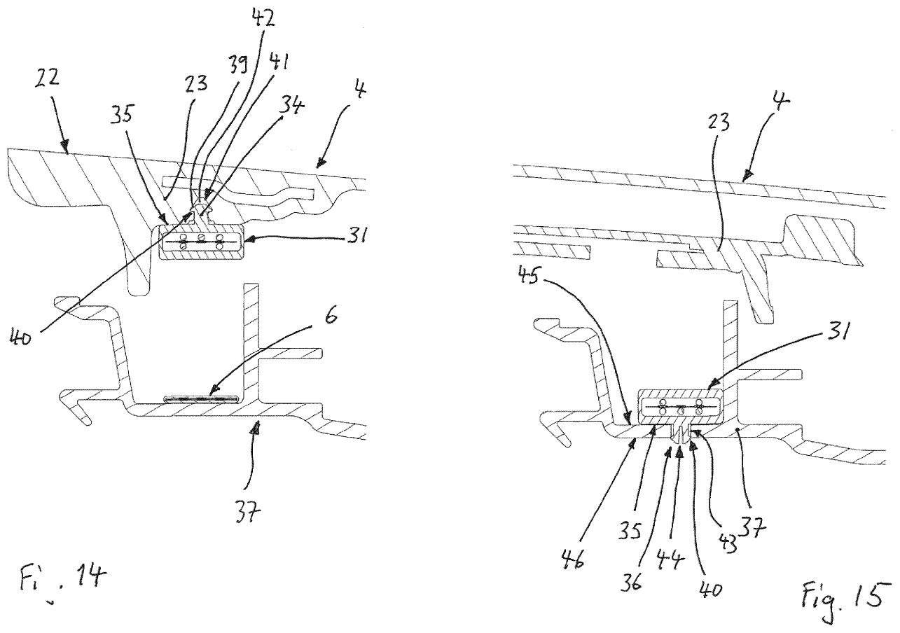

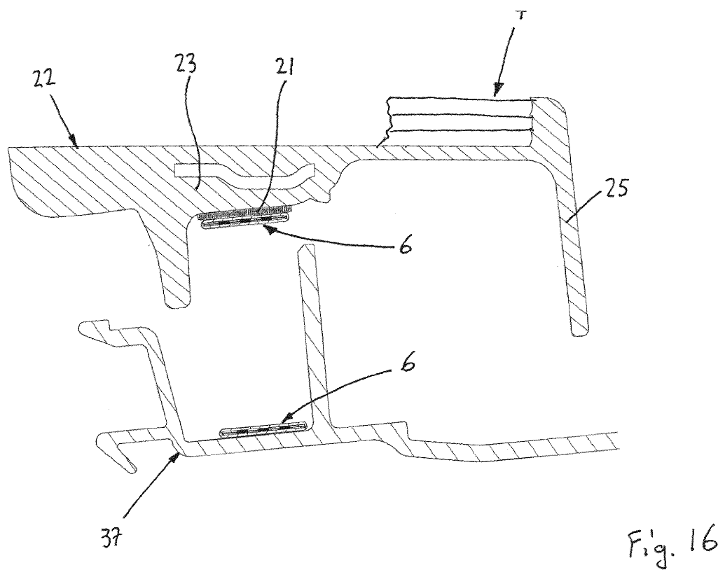

According to one embodiment (see FIGS. 10 to 16), the molded encapsulation 31 of the respectively illustrated contact connection 29 of the trailing cable 6 has a protrusion 32 in the form of a fastening element 34 which is disposed on a fastening face 35 of the molded encapsulation 31 and has a latching head 36. The molded encapsulation 31 on the cover-proximal or front end 9 of the trailing cable 6 bears on the PU foam molding 23 of the cover frame 22 by way of its fastening face 35 (FIG. 14). The other molded encapsulation 31 on the roof-proximal or rear end 8 of the trailing cable 6 bears on a roof frame, and in particular on a guide rail 37 on the roof, by way of its fastening face 35 (FIG. 15).

The fastening element 34 has a base web 38 which extends on the fastening face centrically and in the longitudinal direction approximately over the length of the fastening face 35 and protrudes from the latter. The latching head 36 of the fastening element 34 contains two mutually opposite conical surfaces 39 having lower latching protrusions 40 which project beyond the base web 38. The latching protrusions 40 are spaced apart from the fastening face 35. The PU foam molding 23 of the cover frame 22 has a fastening cutout 41 which is adapted to the fastening element 34 and is formed as an elongate groove having an undercut groove base 42 for receiving in a latching manner the latching head 36 of the fastening element 34 that is inserted into the fastening cutout 41. The fastening cutout 41 is formed so as to be at least slightly longer than the fastening element 34 in such a way that the fastening element 34 is received therein with play in the longitudinal direction when assembling the molded encapsulation 31, but nevertheless assumes its envisaged assembled position on the cover 4 and substantially maintains the latter while taking into account the play.

The fastening element 34 is expediently formed so as to resist deformation, and in particular formed from a material which is harder in comparison to the material of the PU foam molding 23, in such a manner that it has a sufficiently high level of stability when inserted into the fastening cutout 41. However, the fastening element 34 is flexible in such a manner that the PU material of the PU foam molding 23 is elastically deformed by the latching head 36 during insertion.

Disassembly of the molded encapsulation 13 is possible by extracting the fastening element 34 from its latching fixing in the fastening cutout 41.

The molded encapsulation 31 is preferably produced conjointly with the fastening element 34 by a bi-component injection-molding method. In the process, the fastening element 34 can be produced conjointly with the molded encapsulation 31 in one step or in a plurality of steps in one mold or in two molds of an injection-molding tool.

The fastening element 34 can fundamentally be made of a soft material, for example of TPU with a hardness 85.

The fastening element 34 is preferably made of a hard plastics material, for example of a plastics material such as, for example, polyamide (PA) or polypropylene (PP) or polyurethane (PU), which may also contain reinforcement materials such as glass fibers or the like. The fastening element 34 made of hard plastics material is subjected to less deformation when it is being inserted into the fastening cutout 41, this facilitating reliable assembly and fixing. The molded encapsulation 31 is produced from, for example, an elastomer or from a thermoplastic material, preferably based on polyurethane.

The fastening element 34 of the molded encapsulation 31 on the roof-proximal or rear end 8 of the trailing cable 6 is assigned a fastening cutout 43 which is formed in the guide rail 37 (FIG. 15). This fastening element 34 of the other molded encapsulation 31 is formed fundamentally in the same manner as the first-mentioned fastening element 34 of the molded encapsulation 31 on the cover. The guide rail 37 is in particular formed from a light metal such as aluminum, and thus from a hard material in comparison to the PU material of the PU foam molding 23. The fastening cutout 43 is formed, for example, as an opening in the shape of an elongate hole, the length of which is adapted to the fastening element 34 to be inserted, for the purpose of receiving it. The fastening element 34 has a longitudinal slot 44 which extends through the latching head 36 and into the base web 38. The fastening element 34 is inserted into the fastening cutout 43 when the molded encapsulation 31 is attached to an upper side 45 of the guide rail 37. In the process, the longitudinal slot 44 makes it possible for the two halves of the latching head 36 to be pressed against one another under elastic deformation, so that the latching head 36 can be inserted through the fastening cutout 43 which has a smaller width in comparison to the latching head 36. When the molded encapsulation 31 in its assembled position bears on the upper side 45 of the guide rail 37 by way of its fastening face 35, the two halves of the latching head 36 which has been inserted through the fastening cutout 43 spread out to their initial positions again, and the two latching protrusions 40 engage in a latching engagement behind the lower or rear side 46 of the guide rail 37. Even if the fastening element 34 of this molded encapsulation 31 is formed from a hard material, the latching head 36 of the fastening element 34 has the necessary deformation capability for assembly, by virtue of the longitudinal slot 44, because the hardness of the material of the guide rail 37 prevents the latter from being deformed when the latching head 36 is inserted. If the fastening element 34 of this molded encapsulation 31 is formed from a soft material, such a longitudinal slot 44 can be dispensed with. The guide rail 37, or at least that part of the guide rail 37 on which the trailing cable 6 bears and to which the molded encapsulation 31 is fastened, is formed, for example, of metal or of a light metal such as aluminum, or else from a plastics material, and can be designed to be rigid as well as elastic.

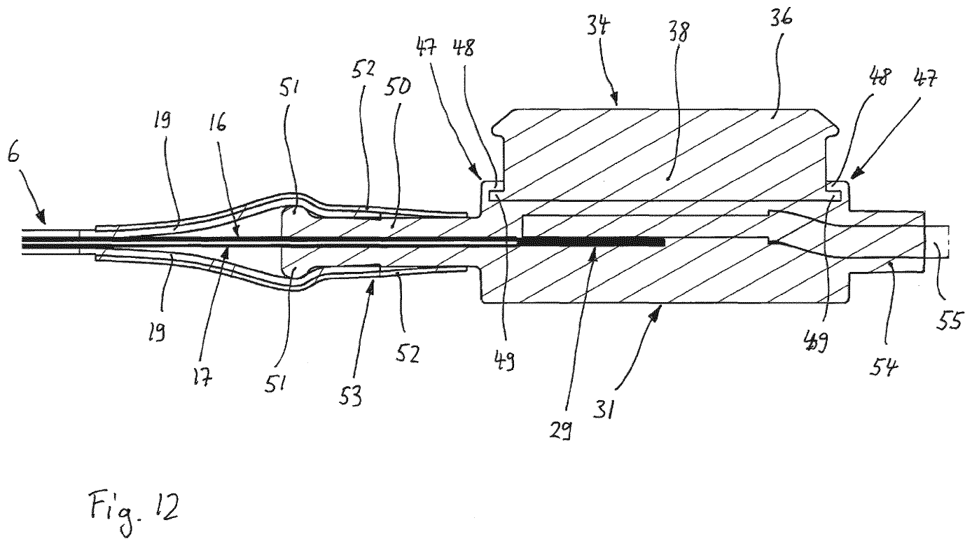

The fastening element 34 is expediently additionally held on the lower end of its base web 38 by means of a form-fitting connection 47 (FIG. 12). The form-fitting connection 47 contains a cross-engagement portion 48 of the molded encapsulation 31, which engages across an extended base 49 or a plate-like plinth of the base web 38, in particular so as to be encircling on the base web 38. As a result, the base web 38 which is integrally molded on the molded encapsulation 31 is secured in relation to being extracted from the molded encapsulation 31.

The molded encapsulation 31 has a fastening flange 50 (FIG. 12) which encloses the two flexible flat cables 16 and 17 and expediently has, on the end side in the longitudinal direction and facing away from the molded encapsulation 31, a thickening in the form of two mutually opposite beads 51. A tubular woven fabric which surrounds the flexible flat cables 16 and 17 as the sheath 19 extends by way of an end portion beyond the beads 51 up to the fastening flange 50 and terminates by way of its end portion so as to preferably be spaced apart from the molded encapsulation 31. At the end side, a shrinkable tubing 52 is pulled onto the flexible flat cables 16, 17 that are surrounded by the sheath 19 and presses the sheath 19, or the tubular woven fabric, against the beads 51 and against the fastening flange 50. In this way, the shrinkable tubing 52 fixes the tubular woven fabric on the fastening flange 50, and seals the two flat flexible cables 16, 17 (FFC) in particular in a sealing region 53 in which said shrinkable tubing 52 bears directly on the fastening flange 50 and also pushes the end region of the tubular woven fabric against the fastening flange 50. In this way, the flexible flat cables 16, 17 are permanently protected in the transition to the molded encapsulation 31. This protection is particularly advantageous on the molded encapsulation 31 on the cover-proximal or front end 9 of the trailing cable 6, because the flexible flat cables 16, 17 are subjected to a higher load here as a result of the bending movement of the trailing cable 6 in the region of the loop 10.

The molded encapsulation 31 preferably contains a flange 54 which lies opposite the fastening flange 50. The insulation sheaths 55 of the individual conductors of the connection line 7 or 13 are injected into this flange 54. A shrinkable tubing which seals the connection line 7 or 13 in relation to the molded encapsulation 31 can also be provided on this flange 54.

The sheath 19 is expediently formed by a tubular woven fabric which is produced from polyester, for example, or by a tubular woven textile fabric. Such a tubular woven textile fabric represents a combination of a tubular woven fabric and a tubular textile which is advantageously softer and causes fewer creaking noises when the trailing cable 6 rubs on the other components such as the PU foam molding 23 of the cover 4 and the guide rail 37. Such a tubular woven textile fabric contains, for example, PET multifilaments and a dense woven textile fabric (PET-HD).

In the production of the trailing cable 6, the sheath 19, or the tubular woven fabric, and the shrinkable tubing 52 are firstly pulled over the free end of the flexible flat cables 16 and 17 lying on top of one another. Subsequently, the contacts 27 of the conductors 18 of the respective flexible flat cable 16 and 17 are connected to the associated contacts 28 of the round conductors of the connection line 7 or 13, which are surrounded by the insulation sheaths 55, as contact connections 29, for example by means of welding, in particular ultrasonic welding, with at least one barrier or insulation layer 30 optionally being disposed therebetween. In the following injection-molding of the molded encapsulation 31, the ends of the flexible flat cables 16, 17 and the ends of the round conductors, and also their contact connections 29, are encapsulated in such a way that they are sealed in the molded encapsulation 31. The fastening element 34 is produced by a bi-component injection-molding method, for example when producing the molded encapsulation 31. After the molded encapsulation 31 has been produced with the fastening element 34, the tubular woven fabric 19 and the shrinkable tubing 52 are disposed on the fastening flange 50. The shrinkable tubing 52 is shrunk by thermal treatment in such a way that it fixes and seals the tubular woven fabric, and thus also fixes and seals the flexible flat cables 16 and 17, on the flange 50.

In an alternative embodiment, the fastening element 34 is produced as an independent component and disposed and fixed on the molded encapsulation 31, for example by adhesive bonding to the fastening face 35 of the molded encapsulation 31, or by inserting the base web 38 into a cutout in the fastening face 35, in which the fastening element 34 is jammed and/or adhesively bonded.

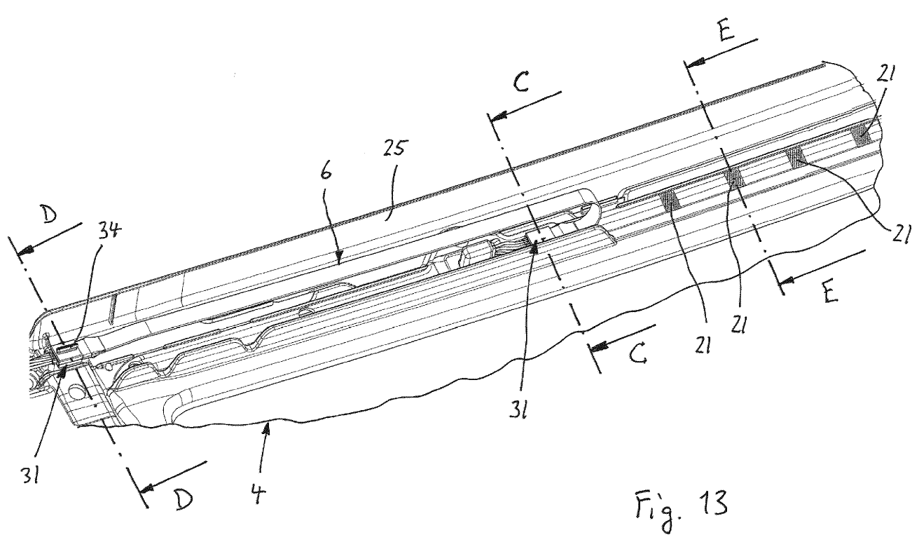

Illustrated in FIG. 13, which illustrates the cover 4 without the guide rail 37, is an embodiment with a plurality of magnets 21 which are disposed so as to be mutually spaced apart on the PU foam molding 23 on the rolling path of the trailing cable 6. The magnets 21, for example neodymium magnets, are adhesively bonded to the PU foam molding 23, or are a foam molding on the latter.

### LIST OF REFERENCE SIGNS

| | |
|---|---|
| 1 | Vehicle roof |
| 2 | Vehicle |
| 3 | Roof opening |
| 4 | Cover |
| 5 | Roof surface |
| 6 | Trailing cable |
| 7 | Connection line |
| 8 | Rear end |
| 9 | Front end |
| 10 | Loop |
| 11 | Rear cover periphery |
| 12 | Lower cover side |
| 13 | Connection line |
| 14 | Peripheral region |
| 15 | Cable assembly |
| 16 | Flexible flat cable |
| 17 | Flexible flat cable |
| 18 | Conductor |
| 19 | Sheath |
| 20 | Spring steel strip |
| 21 | Magnet |
| 22 | Cover frame |
| 23 | Polyurethane foam molding |
| 24 | Cover periphery |
| 25 | Bezel |
| 26 | Cover seal |
| 27 | Contact |
| 28 | Contact |
| 29 | Contact connection |
| 30 | Barrier or insulation layer |
| 31 | Molded encapsulation |
| 32 | Protrusion |
| 33 | Depression |
| 34 | Fastening element |
| 35 | Fastening face |
| 36 | Latching head |
| 37 | Guide rail |
| 38 | Base web |
| 39 | Conical surface |
| 40 | Latching protrusion |
| 41 | Fastening cutout |
| 42 | Groove base |
| 43 | Fastening cutout |
| 44 | Longitudinal slot |
| 45 | Upper side |
| 46 | Form-fitting connection |
| 47 | Form-fitting connection |
| 48 | Cross-engagement portion |
| 49 | Base |
| 50 | Fastening flange |
| 51 | Bead |
| 52 | Shrinkable tubing |
| 53 | Sealing region |
| 54 | Flange |
| 55 | Insulation sheath |

1. A cover of a vehicle roof which is provided for movable mounting on a vehicle roof comprising:
on a lower cover side a trailing cable for an electrical connection to a connection line,
wherein the trailing cable has a cable assembly with at least two flexible flat cables which are disposed so as to lie on top of one another.

2. The cover as claimed in claim 1, wherein the at least two flexible flat cables are disposed so as to lie congruently on top of one another.

3. The cover as claimed in claim 1, wherein the cable assembly is surrounded by a sheath.

4. The cover as claimed in claim 3, wherein the sheath holds the at least two flexible flat cables so as to be positioned so as to lie on top of one another.

5. The cover as claimed in claim 1, wherein the cable assembly is equipped with a magnetic spring steel strip.

6. The cover as claimed in claim 1, wherein contact connections of contacts of each of the at least two flexible flat cable are provided have assigned contacts of the connection lines, which are formed as ultrasonically welded connections or as soldered connections.

7. The cover as claimed in claim 6, wherein a barrier or insulation layer is disposed between the contact connections on the at least two flexible flat cables lying on top of one another.

8. The cover as claimed in claim 1, wherein a molded encapsulation encloses the cable assembly and the connection line in a region of the contact connections.

9. The cover as claimed in claim 5, wherein the cover has at least one magnet that attracts the magnetic spring steel strip in such a position on the lower cover side that the at least one magnet pulls the trailing cable comprising the spring steel strip toward the lower cover side.

10. The cover as claimed in claim 5, wherein the cover has a peripheral cover frame which is formed by a PU peripheral foam molding, and in that the at least one magnet or the molded encapsulation of the contact connections of the trailing cable are fastened to the cover frame.

11. The cover as claimed in claim 8, wherein the molded encapsulation has a fastening element which is produced by a bi-component injection-molding method.

12. The cover as claimed in claim 11, wherein the fastening element has a latching head which is inserted into a fastening cutout on the cover or on a guide rail, on a cover bearing mechanism.

13. The cover as claimed in claim 8, wherein the molded encapsulation has a fastening flange which encloses the flexible flat cables.

14. The cover as claimed in claim 13, wherein an end portion of the sheath of the flexible flat cables is disposed on the fastening flange, and a shrinkable tubing which encompasses the flexible flat cables or the sheath is shrunk onto the fastening flange.

15. A vehicle roof having a cover as claimed in claim 1, wherein the cover is movably mounted on the vehicle roof and is a glass cover of a sliding roof unit.

16. The cover of claim 3, wherein the sheath is a tubular woven fabric or a tubular braided fabric.
